(19) United States
(12) Patent Application Publication
(10) Pub. No.: US 2003/0117505 A1
(43) Pub. Date: Jun. 26, 2003

(54) Intermediate memory for a digital camera

(76) Inventors: Gary David Sasaki, Cupertino, CA (US); Todd Andrew Miklos, Fort Collins, CO (US); Heather Deanne Uhland, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/028,895

(22) Filed: Dec. 20, 2001

(51) Int. Cl. H04N 5/76

(52) U.S. Cl. 348/231.99

(57) ABSTRACT

A digital camera system includes an optical system for forming optical images onto an image sensor. The image sensor provides digital images of the optical images to an intermediate memory. A display provides a visual display of selected digital images stored in the intermediate memory. A controller responds to a manual input from a user to initiate long-term storage of selected digital images from the intermediate memory in a long-term memory.

### TECHNICAL FIELD

The invention relates to digital photography and more specifically to an intermediate memory for a digital camera.

### BACKGROUND

The proliferation and availability of enhanced image sensors, memory devices and microelectronic control systems has prompted many photographers to transition from conventional film photography to digital camera systems. While conventional film photography records a latent image on a photosensitive film that is chemically processed to develop and fix the image in the form of silver compounds or dyes to form a negative or positive image, digital photography typically employs an array of photosensitive electronic devices to produce a digital representation of an image. While conventional film photography results in the image being transferred to film in digital photography, a digital representation of an image is stored in some form of digital memory. Types of memory may be provided in the forms of reusable and consumable digital media. Consumable digital media as used herein refers to a wide range of write-once storage media that may be removed and replaced as desired or needed to store more images. In general, it is expected that the cost of such consumable digital media will drop over time and become relatively inexpensive so that it is eventually economically feasible to provide faster replacement media when existing media is exhausted, e.g., at a cost comparable to conventional photographic film. In addition to single-use consumable digital media, reusable media is also available, although at a cost per picture currently greater than using a comparable single-use consumable digital media.

Examples of consumable and reusable digital media include, but are not limited to, removable media, such as storage cards, Personal Computer Memory Card International Association (PCMCIA) cards, compact flash cards, and MEMORYSTICKS®, and optical and magnetic disk-based media, such as floppy disks, DATAPLAY™, DVD-R, Compact Disc (CD-R) and the like. Providing a removable memory media or module allows a user to carry additional memory media for storage of additional images. The user simply replaces the removable media with a fresh or spare memory media when desired, for example, when the installed memory is filled or has recorded thereon some maximum number of images or some maximum amount of image data. By providing spare memory modules, the user avoids the need to download image data to an external storage device, such as a PC with an associated mass storage device, prior to taking additional photographs after the internal memory is filled.

While the inclusion of a removable media in a digital camera provides a capability similar to that provided by conventional film photography, the paradigm breaks down in as much as, with currently available devices, removable media used in digital photography are still substantially more expensive than a similar “roll of film” used by a conventional film type photographic camera. Thus, various techniques have been adopted to maximize the storage potential of the removable storage media. These techniques include, for example, lossless and lossy image compression to maximize the number of images that may be stored on a device. Also, the user typically downloads image data to a PC with a mass storage device or a writeable CD drive, necessitating a multi-step process to ensure permanent storage outside the digital camera to achieve an effect similar to photographic negatives.

However, such techniques are often perceived to be inadequate to fully bridge the gap between the cost and convenience of storing a digital image in comparison to the cost of storing a corresponding image using conventional film photography. Thus, very inexpensive, removable digital media that can permanently store images offers one way to address the needs of people who wish to treat digital media the way they currently treat film. Such digital media is often called “write-once” because, once written to, that portion of the media cannot be overwritten. However, consumable digital media, being write-once, has the weakness that part of it is “wasted” when a picture is taken that the user wishes to delete, but cannot.

### SUMMARY OF THE INVENTION

According to one aspect of the invention, a digital camera comprises an optical system configured to form an optical image. An image sensor is configured to provide a digital image representation of the optical image. An intermediate memory is configured to store the digital image, and a display provides a visual display of the digital image as stored in the intermediate memory. A long-term image memory selectively stores a plurality of digital images under control of a controller. The controller is configured to selectively initiate long-term storage of the digital image from the intermediate memory into the long-term image memory.

### BRIEF DESCRIPTION OF THE DRAWINGS

FIG. 1 is a block diagram of a digital camera architecture according to a preferred embodiment of the present invention; and

FIGS. 2A and 2B are a flow diagram of a method of taking and storing a picture according to the teachings of the present invention.

### DETAILED DESCRIPTION

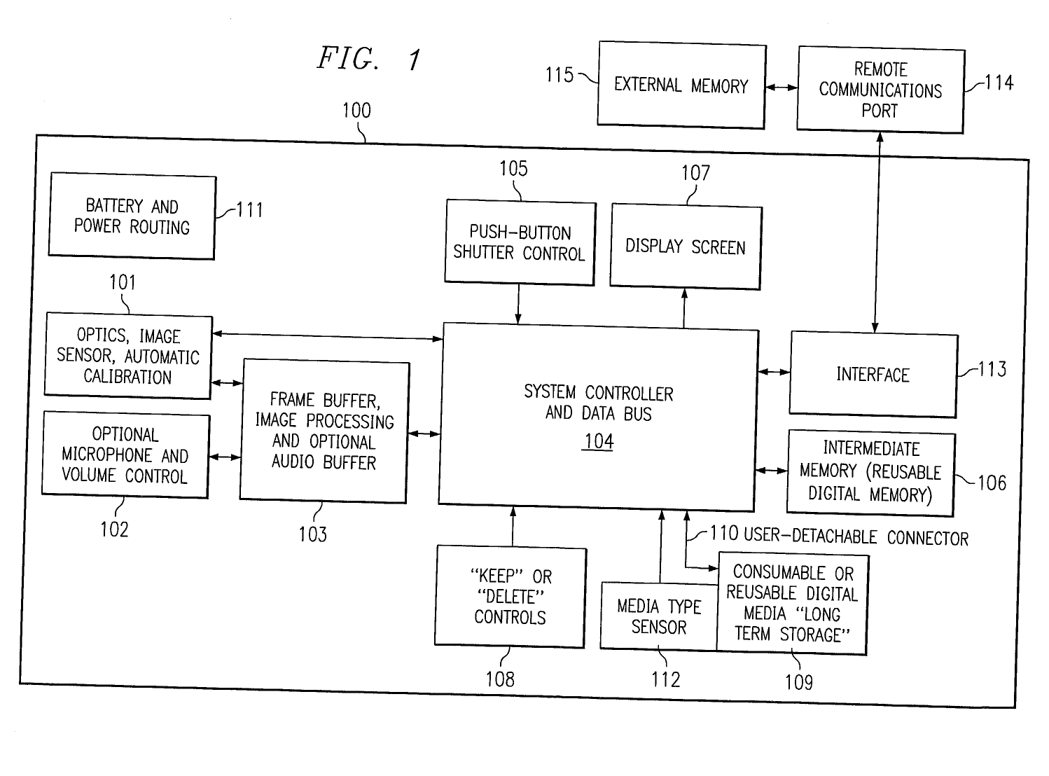

The present invention is directed to a system for and method of providing relatively long-term storage of captured data by the selective storage of data that is held in an intermediate memory device. The captured data may represent a single still image or a sequence of moving images that have been captured by a digital still camera or camcorder-type device. As shown in FIG. 1, camera 100 may include long-term storage device 109, such as a compact flash card, SMARTMEDIA® card, MEMORYSTICK®, floppy disk, CD-R or other disk-based storage device in the form of a removable or permanent digital media. To further enhance storage capabilities, long-term removable media 109 may include a removable single-use consumable digital media, such as a digital memory card, “digital film,” or “d-film.” The camera includes intermediate memory 106 that is capable of temporarily storing some minimum amount of data, such as one or more complete images captured by a still camera or one or more sequences of images captured by a video camera or camcorder. Images or sequences of images are selectively transferred from the intermediate memory 106 and stored in long-term memory 109 in response to a user designation that long-term storage is desired. Alternatively, a user may designate the contents of intermediate memory 106 for erasure, thereby avoiding the writing to long-term storage 109.

A system and method may further implement a default configuration whereby captured images stored in intermediate memory 106 may be automatically saved to long-term storage 109 in response to the initiation of a capture of a subsequent image. Optionally, where intermediate memory 106 stores a plurality of images (or a sequence of images), a default save mechanism may be implemented to save one or more of the images to long-term storage 109 to make room available for capture of a new image into intermediate memory 106 without loss of previously recorded image data. For example, the oldest image or images constituting memory space sufficient to store the newly captured image may be transferred into long-term storage 109 to provide room for the newly captured image or sequence of images. The camera may provide an indication to the user on display 107 or otherwise that intermediate memory 106 is full prior to the automatic storage of data to long-term memory 109 and/or may indicate that an automatic transfer has been initiated in response to the capture of a new image when intermediate memory 106 is full. Camera 100 may further provide for alternative default conditions including, for example, overriding of the oldest image or images that are stored in intermediate memory 106 without automatic saving of those images to long-term memory 109.

A preferred embodiment of the invention includes a digital camera having both a reusable digital memory (“intermediate memory”) and a consumable digital media, such as a one-time-use digital memory card (“digital film” or “d-film”), or optical or magnetic media. The consumable digital media may be removable and replaceable with fresh consumable digital media or even reusable digital media. As with a conventional camera, the user would aim the camera at a subject, and take a photograph by depressing the equivalent of a shutter release to capture an image onto a suitable imaging device, such as a CCD or CMOS sensor. The image may then be displayed for viewing on a screen or a display, such as an LCD (Liquid Crystal Display), that may be located on the camera or viewable through an eyepiece and appropriate optics. The user is then preferably offered the option of either keeping or deleting the image, for example by pushing an appropriate manual input device, such as a button or equivalent control. If the user elects to “keep” the image, then the digital image is stored onto the consumable digital media according to the preferred embodiment. If “delete” is selected, then the digital image is preferably removed from the intermediate memory without being stored on the consumable digital media.

A preferred implementation includes appropriate optics, sensors, and calibration devices to convert the optical image into electronic signals forming a digital image, i.e., a digital photograph. For example, a frame buffer and appropriate image processing is provided for conditioning the image data. An intermediate memory provides for review and selective storage of an image prior to its transfer to and consumption of consumable memory resources. Preferably, a display screen (LCD or similar) and associated controls may be provided to display the picture to the user. Images stored in the intermediate memory may be in either “raw” or compressed form. Thus, for example, the images may be stored as an uncompressed bit map representation, compressed JPEG file, MPEG series of images, etc. External controls (buttons, dials, voice recognition and/or automatic activation) are preferably provided to allow selection of image processing options including whether a particular image is to be kept or deleted. Appropriate electronic buffers, controls, and one-time-use consumable digital media or other appropriate digital media, are preferably included, the digital media providing long-term or even permanent storage of an image. Importantly, the intermediate memory is positioned in series with the removable consumable digital media, allowing it to serve as an image buffer, and if appropriate, a buffer for related information as previously described.

Information about or related to the image may also be stored including a time, date, verbal or textual commentary, picture contents, etc. Such information may include, for example, speech or other commentary input via a microphone or other such input device.

A digital camera according to the teaching of the invention may include optional functionality and defaults. For example, the camera logic may be configured to automatically store an image to consumable digital media in response to a user operating the shutter release control to take another picture prior to designating a desired disposition of a previous image, i.e., before selecting whether to “keep” or “delete (or overwrite)” a previous image. Another arrangement is particularly applicable to a video camera embodiment of the invention in that a sequence of images in the form of a video clip or portion of video clip (with or without sound) may be played and reviewed prior to the user being prompted to decide whether to keep or delete such sequence. Further, although the invention is applicable to an intermediate memory storing a single image, it is equally applicable to storing multiple images in a bank of intermediate memory so as to allow the user to select and keep one or more images. Preferably, the intermediate memory may be configured or treated as a First In, First Out (FIFO) arrangement or queue so as to allow automatic transfer of the earliest taken picture or video clip to consumable digital media.

While the invention is applicable to a camera architecture in that the consumable digital media is removable, it is equally applicable to an architecture in that the consumable digital media may not be user-removable. This may be the case, for example, with an integrated, one-time-use digital camera or disposable video camera. The invention is also applicable to an architecture wherein, for example, re-usable memory is inserted instead of consumable digital media, such that the camera operation reverts back to a conventional mode and writes images directly to memory without user intervention. This mode may be initiated upon recognition by the system that long-term memory may be erased and overwritten, thereby obviating the need for selective storage from an intermediate memory. Alternatively, the system may recognize certain types of memories that, even though reusable, may be used more effectively in combination with intermediate storage according to the invention. For example, the life of reusable memories supporting a limited number of write cycles may be extended by selectively storing images. Likewise, power consumption may be minimized and battery life extended when the process of writing to reusable memory imposes additional power requirements by selectively storing only those images to be kept to long term memory.

Still another configuration of the invention provides for automatic transfer of the photographs or video clips that are stored in intermediate memory (preferably with optional alert given to the user) to consumable digital media as the consumable digital media (or other removable media) is removed from the device. The invention also includes the alternative of providing for the transfer of the photographs or video clips that are stored in intermediate memory to another device, via cable or wireless interface, whereupon the transferred images or clips are deleted from the intermediate memory or transferred to consumable digital media. That is, a photograph or video clip does not have to be stored in consumable digital media before it is transferred to another device.

As would be understood by those of ordinary skill in the art, one advantage of the invention is provided by the combination of an intermediate memory, a one-time-use consumable digital media and the ability to choose to “keep” or “delete” an image, thereby allowing the user to enjoy the benefits of instant review and optional delete of unwanted pictures. It will be understood that, as used herein, delete means to designate or make memory space available to be overwritten, whether or not the original data is actually erased. These advantages in the context of a digital camera are provided while maintaining the permanence and familiarity associated with conventional silver-halide-based photographic film. As will also be apparent to one of ordinary skill in the art, such issues become particularly important when the storage media (e.g., consumable digital media) is provided in a write-once or non-erasable configuration. In such case, the intermediate memory allows the user to permanently keep only the desired items while allowing images or video clips to be retaken or to be eliminated without being stored on consumable digital media. Thus, the invention solves the problem of using a one-time-use memory to save unwanted images, thereby more efficiently and effectively using such memory. Provision of an intermediate memory also provides other advantages. For example, a user may change long term storage media after taking a picture so that the image can be stored on an appropriate or preselected memory device. Thus, a user may maintain one removable media for scenery images, while storing pictures of people on a different removable media.

Referring to FIG. 1, a digital camera embodiment of the invention is depicted in the form of a block diagram. Digital camera 100 is preferably housed in a suitable ergonomic, hand holdable enclosure typical of conventional imaging devices, e.g., digital cameras and the like. Within this common housing, suitable optics 101 are included together with an appropriate image sensor and automatic calibration devices. Optics may include a suitable multi-element lens system having an autofocus capability and provision for zooming to a desired focal length, preferably without changing focus. The image sensor may be an interline transfer device suitable for consumer digital camera uses, a full frame sensor, typically used in professional cameras, or other device capable of detecting an image and providing a corresponding digital image. Also included as part of the functionality shown in box 101 is the provision of automatic calibration for adjusting such parameters as white balance, video levels, etc.

In addition to capturing an image, digital camera 100 may include suitable transducers and/or other input devices for accepting other media, including, for example, sound. Thus, an optional microphone and suitable volume control may be provided as shown in box 102. Outputs from optical system 101 and from optional microphone 102 are provided to frame buffer 103 that performs image processing and optional audio buffering. The combined output from frame buffer 103 is provided to system controller 104, which includes an appropriate data buffer for transferring data between and among the functional units of digital camera 100. In addition to routing data, system controller 104 includes control paths for providing control information to, and receiving inputs from, other functional facilities of camera 100 including optical system 101. Thus, system controller 104 receives input from various user actuated inputs, including, for example, push button shutter control 105 and controls 108 for selecting images and for designating whether the images are to be kept or deleted. System controller 104 also provides appropriate commands to display screen 107 to cause it to download and display an image from intermediate memory 106. System controller 104 may also include working memory, which is the memory required to process an image as it is being taken and where the image is held prior to being stored into intermediate memory or the removable media.

As shown in FIG. 1, image data from the data bus may be transferred under the control of systems controller 104 from frame buffer 103 to intermediate memory 106. This would normally occur upon image acquisition as initiated by a user operating push button shutter control 105 and appropriate processing of the image as it is captured by optical system 101 and transmitted through frame buffer 103 into intermediate memory 106. Such processing may include, for example, white balancing, gain control image demosaicing, etc.

Intermediate memory 106 acts as a temporary image store in the form of a reusable digital memory for storing a digital image prior to committing that image to long-term image memory storage in digital media 109. Further, intermediate memory 106 provides a means for display screen 107 to display an image for review by a user and to assist the user in designating whether the image is to be kept or deleted. While intermediate memory 106 may store one or more digital images, it is expected that the memory storage capability of intermediate memory 106 would be less than provided by digital media 109.

It should be noted that, although a consumable type of digital media 109 is described as a high density, one-time-use memory card (e.g., consumable digital media), other forms of long-term image memory storage devices may be provided. Such alternative long-term storage devices may include, for example, storage cards including PCMCIA PC card, compact flash cards, SMARTMEDIA, SONY MEMORYSTICK®, SECURE DIGITAL, floppy disks, micro drives, optical storage media, and other devices now known or developed in the future.

Preferably, camera 100 includes a sensor 112 to detect the type of digital media 109 to adjust camera parameters including storage characteristics consistent with the type of consumable digital media Further, camera 100 may detect whether digital media 109 is erasable or is write-once, read many (WORM), i.e., non-erasable. In the case of an erasable consumable type digital media 109, camera 100, under control of system controller 104, may bypass storage of image data into intermediate memory 106 and, instead, directly store images into consumable digital media 109, offering the user the ability to delete images from consumable digital media 109. Alternatively, upon detection of a non-erasable-type digital media 109, system controller 104 may automatically implement processing as described above wherein image data from intermediate memory 106 is only transferred to digital media 109 upon user selection or upon initiation of a default condition to avoid loss of image data. Thus, in this normal configuration wherein consumable type digital media 109 is non-erasable, images are only selectively stored into the consumable type digital media 109 while, when the images may be subsequently erased, the default condition may be to automatically initiate storage of data into reusable type digital media 109.

Referring again to FIG. 1, a user-detachable connector 110 may be included to connect digital media 109 to system controller 104 and the remainder of camera 100 including intermediate memory 106, thereby allowing removal and replacement of digital media 109. As also shown, other support functionality is provided in a conventional manner, including, for example, battery and power routing functionality 111. Interface 113 provides communications with and transfer of image data to other systems including, for example, an external memory 115 via a remote communication port 114. Remote communication port 114 and external memory may be part of a personal computer or an electronic imaging appliance.

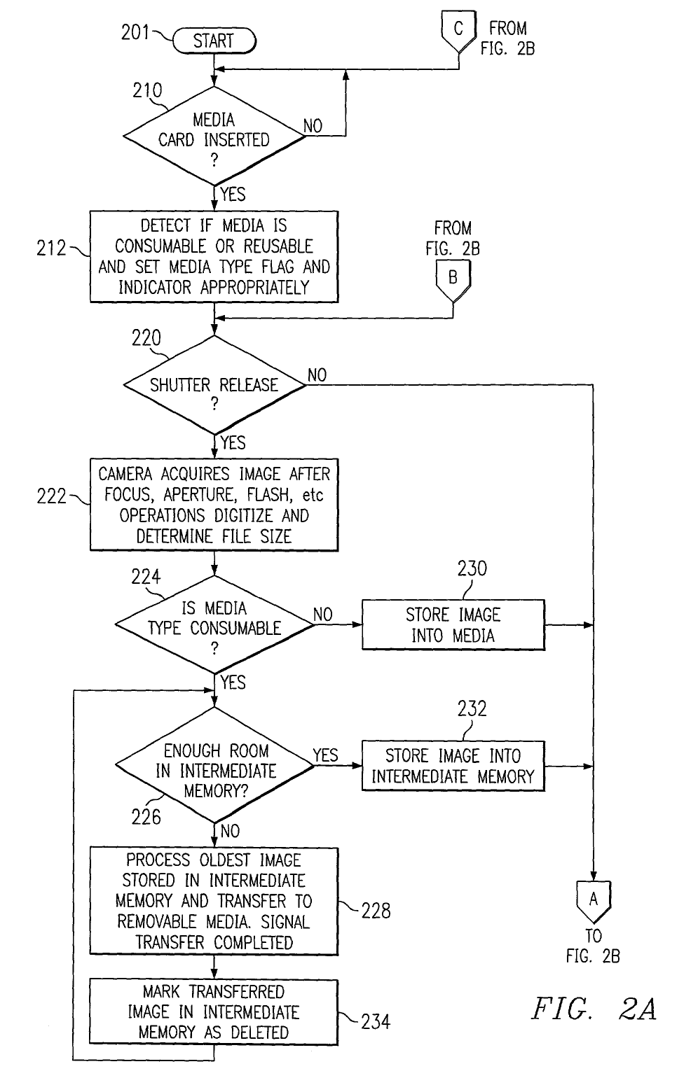

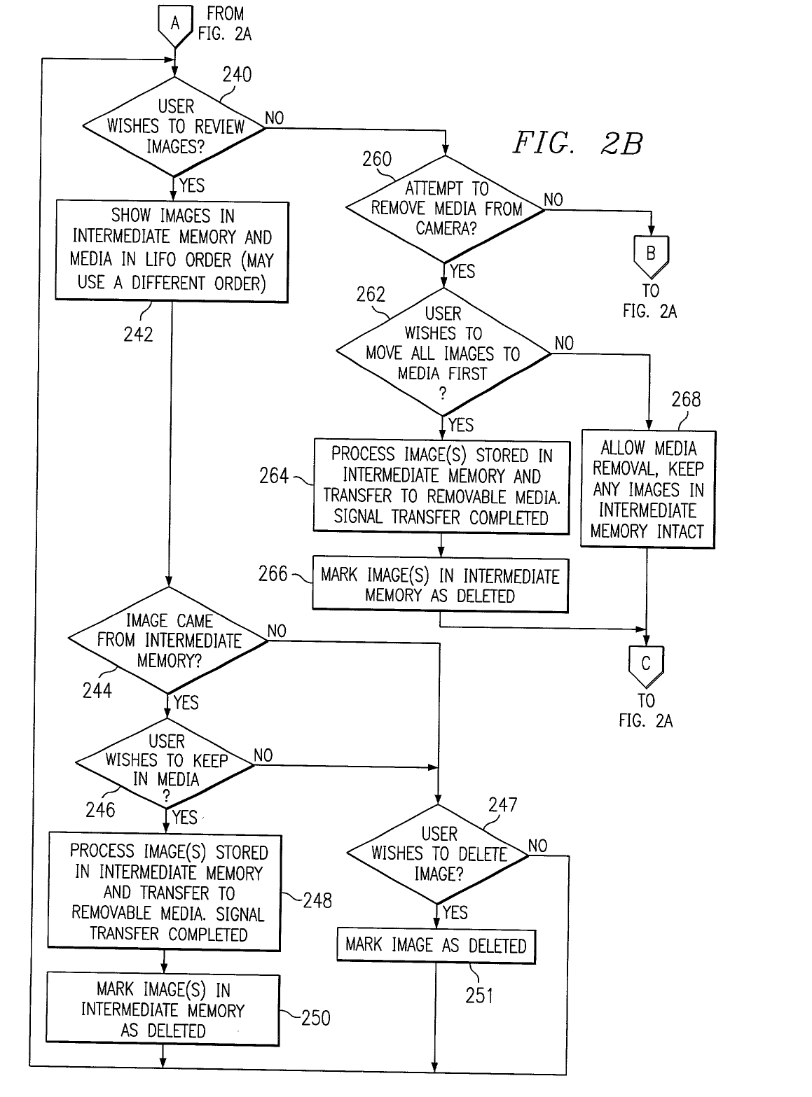

FIGS. 2A and 2B illustrate an exemplary flow diagram for a method of operating a digital camera according to a preferred embodiment of the invention. The method is entered at step 201 and, at decision 210, a test is performed to determine if a media card is inserted. Processing continues to loop at decision 210 until the presence of a media card is detected. Note that this test may be omitted in certain camera configurations. For example, a disposable camera having a built-in consumable media may skip this test because the camera is provided with a non-removable media installed. Another situation in which the test of decision 210 may be bypassed is when the camera is configured to allow a user to take pictures and store them in intermediate memory for later transfer to a removable digital media, such as a later inserted media card. Upon detection of a new media card, processing is performed at 212 to detect that the media is consumable or reusable and to set an appropriate media-type flag and indicator. This detection step may be responsive to an electrical sensor input or performed by appropriate processing that reads some area of the media to determine whether it is consumable or reusable or performs some other sort of testing such as a write/read test to determine the type of memory inserted.

Processing continues at decision 220 where a test is performed to determine if the shutter released has been operated. If so, then process 222 is performed whereupon the camera acquires an image after performing appropriate focusing, aperture setting, flash and other operations necessary to acquire the image and, subsequently, the image is digitized and a file size determination is performed. Next, at decision 224, a test is performed to see if the media-type is consumable, (i.e., write-once or non-erasable) as opposed to a reusable or erasable type of digital media. Failing this test (for example, if it is determined that the media is erasable), flow continues to process 230 wherein the image is stored into the media.

Alternatively, if the media-type is consumable, then processing continues at decision 226 to test if there is sufficient room in the intermediate memory to store the recently acquired image. If sufficient memory is available, then processing continues at 232 to store the image into the intermediate memory. If insufficient memory is available, then processing continues at 228 to process the oldest image stored in the intermediate memory and to transfer the image to the removable media and signal transfer is completed.

Next, at step 234, the transferred image is marked in intermediate memory as deleted and flow continues back to decision 226 to retest to see if there is now sufficient room in the intermediate memory to store the recently acquired image. If there is still insufficient intermediate memory, then the next oldest image is processed for storage at 228 and marked for deletion at 234 from the intermediate memory. This loop continues until sufficient memory is available. Upon detecting that there is enough room in the intermediate memory to store the recently acquired image, it is stored into the intermediate memory at step 232.

Steps 220 through 234 describe a process appropriate for still photos or video clips, where working memory (FIG. 1, 104) can store images (and sound) until a decision is made on whether to store in intermediate memory or media. In cases where the camera can capture long sequences of video clip, the working memory may not be sufficiently large to handle the entire clip in step 222 before moving onto step 224. In such cases the clip can be divided into clip segments or blocks. As each segment limit is filled, the process moves through steps 224-234. Meantime, the camera's working memory is used to process the next segment being captured.

After appropriate processing has been performed to accommodate the insertion of a new media card ( 210 et seq.) or to capture a new image in response to activation of the shutter release (220 et. seq.), processing continues at decision 240 (FIG. 2B) to determine if a user wishes to review images stored in the camera. If so, then processing continues at 242 to show images in the intermediate memory and/or media in Last-In First-Out (LIFO) order. Of course, other sequencing of images may be used including, for example, First-In First-Out (FIFO) or some other user-selected sequence. Processing then continues to decision 244 where a test is performed to determine if the viewed image came from intermediate memory. If not, i.e., the image being viewed is stored, e.g., in a removable digital memory card, then processing continues at decision 247 to test to see if the user wishes to delete the image. This option allows a user to delete and reuse memory resources that are associated with an image that was previously stored in an erasable-type digital media or to mark an image stored in a non-erasable consumable digital media as not to be printed. Thus, if the image is to be deleted, then it is marked as such at step 251.

If the displayed image is determined to be stored in intermediate memory at decision 244, then processing continues to decision 246 where a test is performed to see if the user wishes to keep the image by storing it in the removable digital memory card, i.e., a long term image memory media. If so, then processing continues at 248 to effect storage of the image. In particular, processing is performed of the image as stored in the intermediate memory and the processed images are transferred to the removable media and signal transfer is completed at 248. The images transferred from the intermediate memory are then marked as deleted at step 250 and processing continues back to decision 240 to again test to see if the user wishes to review images.

If, at decision 246, the user does not wish to keep the image stored in intermediate memory by storing it into the digital media, then processing flows to 247 to test to see if the image is to be deleted. If the image is to be deleted, then it is so marked at step 251, otherwise, no action is taken. In either case, processing continues at decision 240 to test whether the user wishes to review more images.

If the user does not review images in step 240, the process moves to step 260. A final test is performed at decision 260 to see if there is an attempt to remove the media from the camera. Appropriate processing in response to removal of the media is performed beginning at decision 262 where a test is performed to see if the user wishes to store all images to the media prior to removal of the media from the camera. If the user indicates that images are not to be transferred, then at 268, the media is allowed to be removed while any images in intermediate memory are kept intact. Conversely, if the user wishes to move all images to media first, then the test at 262 is passed and, at 264, the images are stored and the intermediate memory are processed and transferred to the removable media and signal transfer is completed. At 266 the portion of intermediate memory which contained the transferred image is marked as deleted and processing continues back at decision 210.

In the cases where the processing of FIGS. 2A and 2B accommodates an intermediate memory capable of storing several complete images or video segments, then certain of the steps and decisions may include further options to allow the user to select one of the plurality of stored images for storage, i.e., to be “kept” or to be “deleted”. Further, although not shown, other default conditions may be incorporated other than as shown or described. For example, operation of the shutter release may be inhibited if there is insufficient storage available in the intermediate memory and until such time as such condition is remedied by user selection of an image to be transferred into long-term storage.

What is claimed is:

1. A digital camera for:
providing digital images of optical images, the camera comprising;
an intermediate memory for storing said digital images;
a display for providing a visual display of said digital images stored in said intermediate memory;
long-term image memory for storing a plurality of digital images; and
a controller for selecting digital images from said intermediate memory and storing said selected digital images in said long-term image memory.

2. The digital camera of claim 1 wherein said controller further comprises:
a manual input device for providing user selection of said digital images that are to be stored in said long-term image memory from the intermediate memory.

3. The digital camera of claim 1 wherein said long-term image memory comprises:
a removable consumable digital media.

4. The digital camera according to claim 1 wherein said intermediate memory is organized to provide selective transfer or First-In First-Out (FIFO) transfer of images to said long-term image memory or both.

5. The digital camera of claim 4 wherein said controller automatically stores one or more intermediate memory digital images in said long-term image memory in response to a capture of a subsequent digital image when it is determined that room needs to be created in said intermediate memory to store the subsequent digital image.

6. The digital camera of claim 1 wherein said intermediate memory automatically overwrites one or more of said digital images in said intermediate memory with a subsequently acquired digital image.

7. The digital camera of claim 1 wherein said intermediate memory stores a plurality of digital images and said controller is configured to select ones of said digital images in said intermediate memory for long-term storage in said long-term image memory; and
wherein storage space in said intermediate memory that was previously occupied by said selected ones of said digital images is made available for the storage of subsequent captured digital images.

8. The digital camera of claim 1 wherein said controller is responsive to detecting an erasable type of said long-term image memory and wherein said controller automatically stores said digital images into said long-term image memory.

9. The digital camera of claim 1 wherein said intermediate memory stores a plurality of digital images in a First-In, First-Out (FIFO) arrangement whereby, upon said intermediate memory becoming filled, prior to storage of a subsequent digital image into said intermediate memory, a number of oldest ones of said digital images in said intermediate memory are automatically stored into said long-term image memory to make required space available for said subsequent digital image.

10. The digital camera of claim 1 wherein said controller initiates processing to prepare for removing said long-term image memory from said digital camera including transfer of said digital image from said intermediate memory into said long-term image memory.

11. The digital camera of claim 1 wherein said controller is selectively operable to transfer a digital image from said intermediate memory to said long-term image memory or to a communications port providing connectivity with remote external memory or to both.

12. The digital camera of claim 1 further comprising:
a sensor for detecting an attempt to remove said long-term image memory from said digital camera; and
means for processing a digital image stored in said intermediate memory to indefinitely retain said image in said intermediate memory.

13. The digital camera of claim 1 wherein said long-term image memory is a replaceable memory module.

14. The digital camera of claim 13 wherein said replaceable memory module comprises a consumable digital medium.

15. A method of processing a digital image, comprising:
storing said digital image in an intermediate memory;
displaying a visual image of said digital image in said intermediate memory; and
selectively storing said digital image to a long-term image memory from said intermediate memory.

16. The method of claim 15 further comprising:
compressing said digital image in said intermediate memory prior to selectively storing said digital image to said long-term image memory.

17. The method of claim 15 further comprising:
recognizing said long-term image memory as non-erasable.

18. A digital image capture system comprising:
sensor means for providing a digital image of an optical image;
first storage means for storing said digital image;
display means for providing a visual display of said digital image in said first storage means;
second storage means for storing a plurality of digital images; and
control means for selecting digital images in said first storage means for storage in said second storage means.
